(19) United States
(12) Patent Application Publication
(10) Pub. No.: US 2026/0255265 A1
(43) Pub. Date: Aug. 27, 2026

(54) MULTI-LINK POWER SAVE INDICATION

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/550,670

(22) Filed: Feb. 26, 2026

Related U.S. Application Data
(60) Provisional application No. 63/764,090, filed on Feb. 27, 2025.
(60) Provisional application No. 63/763,669, filed on Feb. 26, 2025.
(60) Provisional application No. 63/763,428, filed on Feb. 26, 2025.

(51) Int. Cl. H04W 52/02; H04L 1/1607; H04W 72/20

(52) U.S. Cl. CPC H04W 52/0206; H04L 1/1614; H04W 72/20

(57) ABSTRACT

Multi-link power save (MLPS) indication may be provided. An access point (AP) multi-link device (MLD) establishes a plurality of links with a non-AP MLD. The AP MLD receives, via a link of the plurality of links, an MLPS indication and determines a power management (PM) mode for two or more links of the plurality of links based on the MLPS indication, including determining at least a first link of the two or more links is in an active mode and determining at least a second link of the two or more links is in a power save mode. The AP MLD manages communications with the non-AP MLD based on the PM mode for the two or more links.

### RELATED APPLICATION

Under provisions of 35 U.S.C. § 119(e), Applicant claims the benefit of and priority to U.S. Provisional Application No. 63/763,428, filed Feb. 26, 2025, U.S. Provisional Application No. 63/763,669, filed Feb. 26, 2025, and U.S. Provisional Application No. 63/764,090, filed Feb. 27, 2025, the disclosures of which are incorporated herein by reference in their entirety.

### TECHNICAL FIELD

The present disclosure relates generally to providing multi-link power save (MLPS) indication.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing multi-link power save (MLPS) indications in accordance with aspects of the present disclosure.

FIG. 2 illustrates an example Aggregated-Media Access Control Data Unit for transmitting the MLPS indication in accordance with aspects of the present disclosure.

FIG. 3 illustrates a first example Control Information subfield in accordance with aspects of the present disclosure.

FIG. 4 illustrates a second example Control Information subfield in accordance with aspects of the present disclosure.

FIG. 5 illustrates a third example Control Information subfield in accordance with aspects of the present disclosure.

FIG. 6 illustrates a fourth example Control Information subfield in accordance with aspects of the present disclosure.

FIG. 7 illustrates a fifth example Control Information subfield in accordance with aspects of the present disclosure.

FIG. 8 illustrates a sixth example Control Information subfield in accordance with aspects of the present disclosure.

FIG. 9 illustrates a seventh example Control Information subfield in accordance with aspects of the present disclosure.

FIG. 10 illustrates an eighth example Control Information subfield in accordance with aspects of the present disclosure.

FIG. 11 illustrates a ninth example Control Information subfield in accordance with aspects of the present disclosure.

FIG. 12 illustrates a tenth example Control Information subfield in accordance with aspects of the present disclosure.

FIG. 13 various Control Information subfield formats that incorporate timing control functionality in accordance with aspects of the present disclosure.

FIG. 14 is a flow diagram illustrating a method for providing MLPS indications in accordance with aspects of the present disclosure.

FIG. 15 is a flow diagram illustrating a method for communicating using MLPS indications in accordance with aspects of the present disclosure.

FIG. 16 is a block diagram of a computing device in accordance with aspects of the present disclosure.

FIG. 17 is a block diagram of a communications device in accordance with aspects of the present disclosure.

### DETAILED DESCRIPTION

### Overview

Multi-link power save (MLPS) indication may be provided. An access point (AP) multi-link device (MLD) establishes a plurality of links with a non-AP MLD. The AP MLD receives, via a link of the plurality of links, an MLPS indication and determines a power management (PM) mode for two or more links of the plurality of links based on the MLPS indication, including determining at least a first link of the two or more links is in an active mode and determining at least a second link of the two or more links is in a power save mode. The AP MLD manages communications with the non-AP MLD based on the PM mode for the two or more links.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The IEEE 802.11bn standard defines multi-link (ML) operation capabilities for wireless communication networks. One aspect of multi-link operation involves multi-link power save (MLPS) functionality, where a station (STA) operating as part of a multi-link device (MLD) can signal a Power Management (PM) mode for one or more links on another link. This cross-link signaling approach is intended to minimize overhead for PM indication and enable a STA to signal the PM mode for multiple links simultaneously without requiring separate transmissions on each individual link.

The PM mode indicates whether a link is operating in one of an active mode or a power save (PS) mode. For example, a PM mode set to 0 (PM=0) indicates that a respective link is in active mode, while a PM mode set to 1 (PM=1) indicates that a respective link is in power save mode. Utilizing cross-link signaling for communicating multi-link operation-related control information related to one or more links, even when the information is not related to the link on which it is transmitted, enables efficient management of multiple links while reducing signaling overhead.

The current proposals for encoding MLPS information present certain limitations. Specifically, existing encoding schemes for MLPS indications in Aggregate (A)-Control fields allow a non-Access Point (AP) MLD (e.g., a client device) to indicate only a single PM mode (either PM=0 or PM=1) in a given MLPS A-Control subfield. When a non-AP MLD needs to indicate PM=0 for some links and PM=1 for other links, it cannot report both PM modes in the same frame or MLPS A-Control subfield. This limitation can increase overhead, reduce signaling efficiency, and limit the flexibility of multi-link power management operations.

The present disclosure provides multiple optimized encoding options for MLPS indications in A-Control fields that address the limitations of current approaches. The described MLPS indication mechanisms provide several advantages, including increased reliability of power mode signaling, increased speed of PM mode notification across multiple links, reduced frame size requirements, increased power savings through more efficient signaling, and enhanced flexibility to indicate one or both PM modes as needed by the non-AP MLD. Different approaches can be utilized for encoding MLPS information, including encoding schemes that enable indication of both PM modes in a single A-Control subfield, variable-length bitmap formats that optimize overhead based on the number of links being managed, dual-bitmap approaches that separately indicate links in each PM mode, flexible format indicators that allow the non-AP MLD to select between compact single-mode encoding and comprehensive dual-mode encoding, and timing indications that specify when the indicated PM modes become effective.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B and C.” An exception to this definition will occur only when a combination of elements, functions, steps, or acts are in some way inherently mutually exclusive.

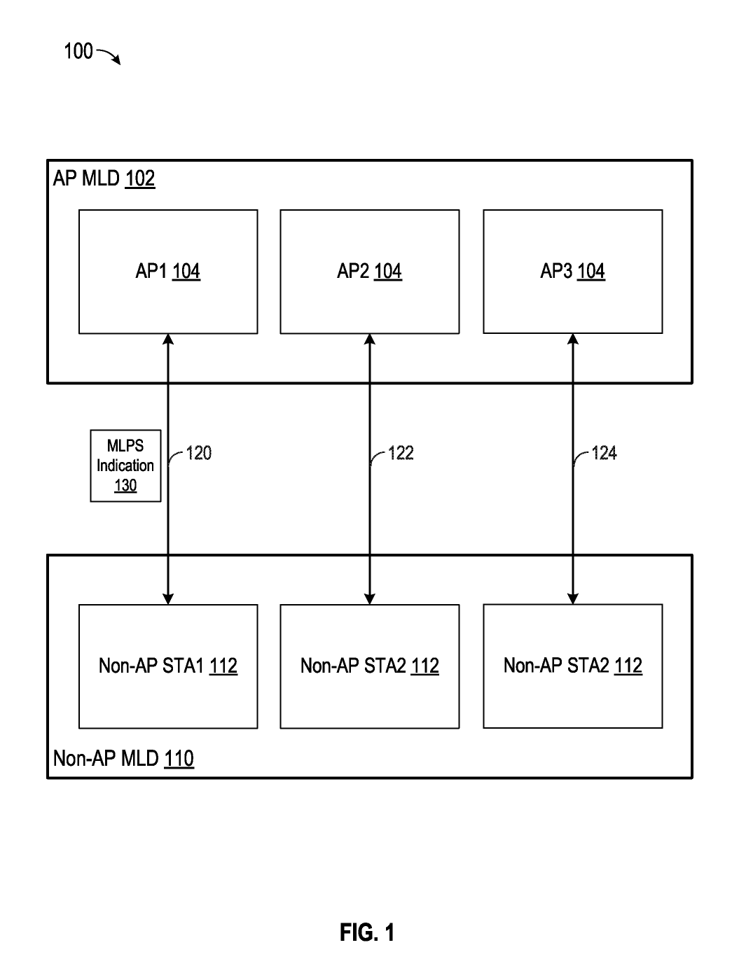

FIG. 1 is a block diagram of an operating environment 100 for providing MLPS indications. The operating environment 100 includes an AP MLD 102 and a non-AP MLD 110 configured to communicate over multiple wireless links in accordance with IEEE 802.11 wireless communication standards, such as IEEE 802.11bn.

The AP MLD 102 includes a plurality of affiliated STAs 104, illustrated in FIG. 1 as AP1 104, AP2 104, and AP3 104. Similarly, the non-AP MLD 110 includes a plurality of affiliated non-AP STAs 112, illustrated as non-AP STA1 112, non-AP STA2 112, and non-AP STA3 112. Each STA 104 and non-AP STA 112 may include Physical (PHY) layer components and lower-Media Access Control (MAC) layer components for managing wireless communications on their respective links. The AP MLD 102 and the non-AP MLD 110 may each also include an upper-MAC layer for coordinating the respective affiliated STAs 104, 112 and providing Logical Link Control (LLC) functionality. In some embodiments, the AP MLD 102 can access a distribution system (DS) to communicate with other Basic Service Sets (BSSs) and network infrastructure.

In the illustrated embodiment, the AP MLD 102 and the non-AP MLD 110 establish multiple wireless links for multi-link operation. Specifically, a first link 120 connects AP1 104 with non-AP STA1 112, a second link 122 connects AP2 104 with non-AP STA2 112, and a third link 124 connects AP3 104 with non-AP STA3 112. Each of these links can operate on different frequency bands or channels to provide enhanced throughput, reliability, and flexibility. In an example implementation, the first link 120 operates in the 2.4 Gigahertz (GHz) frequency band, the second link 122 operates in the 5 GHz frequency band, and the third link 124 operates in the 6 GHz frequency band. Other frequency bands and channel configurations may be utilized in further implementations.

While the illustrated embodiment shows three affiliated STAs in both the AP MLD 102 and the non-AP MLD 110, other embodiments may include a different number of affiliated STAs and corresponding links. For example, an MLD may include two, four, five, or more affiliated STAs depending on the capabilities of the device and the wireless environment. Additionally, the operating environment 100 may include additional devices not shown in FIG. 1, such as additional non-AP MLDs in the same BSS as the AP MLD 102, or additional AP MLDs in overlapping or adjacent BSSs. In certain embodiments, the non-AP MLD 110 may establish links with multiple AP MLDs to provide enhanced connectivity options.

An MLPS indication 130 is transmitted from the non-AP MLD 110 to the AP MLD 102 to signal the PM mode for one or more of the links 120, 122, 124. In the illustrated embodiment, the MLPS indication 130 is sent via the first link 120. However, in other embodiments, the MLPS indication 130 may be transmitted via any of the established links (e.g., the second link 122 or the third link 124) and may be directed to different AP MLDs when the non-AP MLD 110 has links with multiple AP MLDs. This cross-link signaling capability allows the non-AP MLD 110 to communicate power management information for multiple links using a single transmission on one link, thereby reducing overhead and improving signaling efficiency.

The MLPS indication 130 enables the AP MLD 102 to determine which of the links 120, 122, 124 are operating in active mode (PM=0) and which links are operating in power save mode (PM=1). When a link is in active mode, the corresponding non-AP STA 112 is actively listening for transmissions and can receive data at any time. Conversely, when a link is in power save mode, the corresponding non-AP STA 112 enters a low-power state and may not be actively listening for transmissions, thereby conserving battery power. By providing this power management information through the MLPS indication 130, the non-AP MLD 110 informs the AP MLD 102 of the current or intended PM mode for each link, allowing the AP MLD 102 to appropriately schedule transmissions and manage communications with the non-AP MLD 110.

Upon receiving the MLPS indication 130, the AP MLD 102 can utilize the information to determine which links are available for communication. For example, if the MLPS indication 130 indicates that the first link 120 and the second link 122 are in active mode (PM=0) and the third link 124 is in power save mode (PM=1), the AP MLD 102 can determine to transmit data to the non-AP MLD 110 using the first link 120 and/or the second link 122, while refraining from transmitting on the third link 124 or following appropriate power save protocols for that link. This coordination improves overall network efficiency and reduces unnecessary power consumption at the non-AP MLD 110.

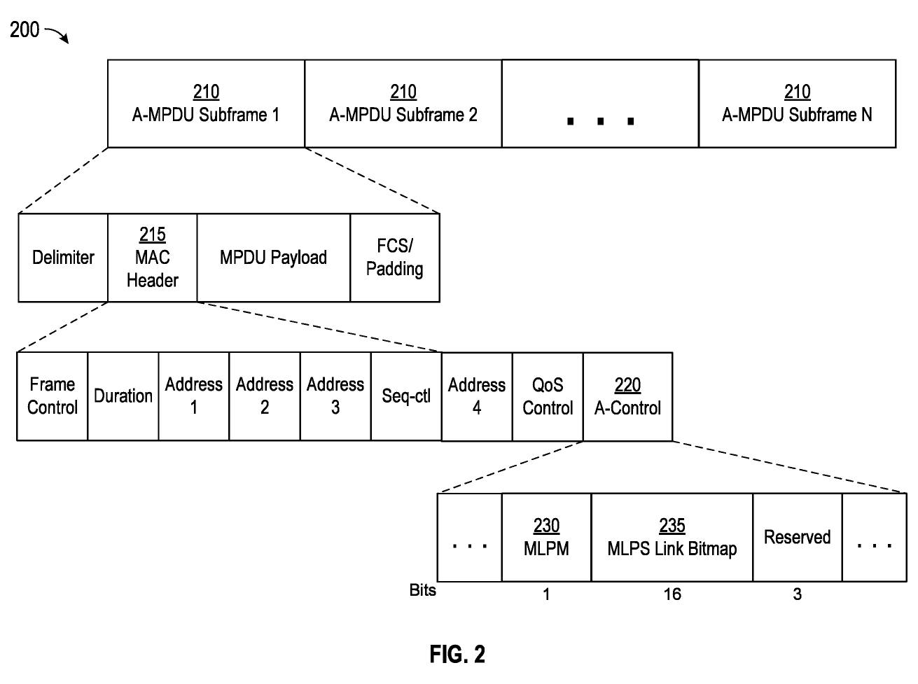

As will be described in further detail herein with respect to FIGS. 2-13, the MLPS indication 130 may be encoded in various formats within an A-Control field. These encoding schemes provide enhanced flexibility and efficiency compared to conventional approaches. In some embodiments, the encoding options include encoding schemes that enable indication of both PM=0 and PM=1 modes in a single MLPS A-Control subfield, thereby allowing the non-AP MLD 110 to simultaneously signal that some links are active while other links are in power save mode. In further embodiments, the encoding options include variable-length bitmap formats that optimize overhead based on the number of links being managed (such as dynamically selecting between 8-bit and 16-bit bitmaps), dual-bitmap approaches that separately indicate links in PM=0 mode and links in PM=1 mode using distinct bitmap fields, flexible format indicators that allow the non-AP MLD 110 to select between a compact single-mode encoding (when only one PM mode needs to be indicated) and a more comprehensive dual-mode encoding (when both PM modes need to be indicated for different links), and timing indications that specify when the indicated PM modes become effective, such as a start time expressed in terms of Timing Synchronization Function (TSF) values. These various encoding options provide the non-AP MLD 110 with the capability to efficiently communicate power management information in a manner that is tailored to the specific operational requirements and link states, thereby reducing signaling overhead, improving power savings, and enhancing overall ML operation performance.

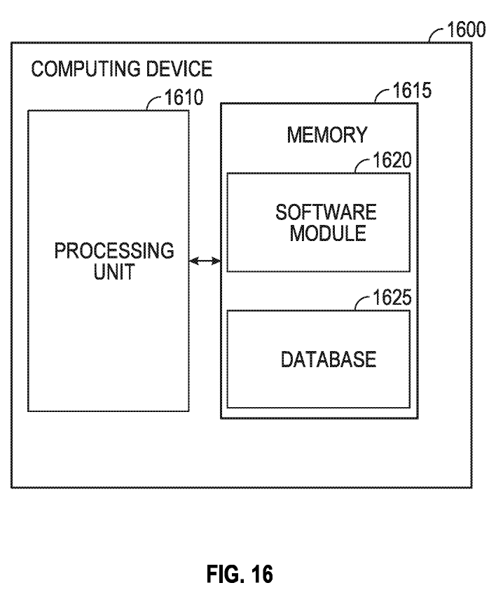

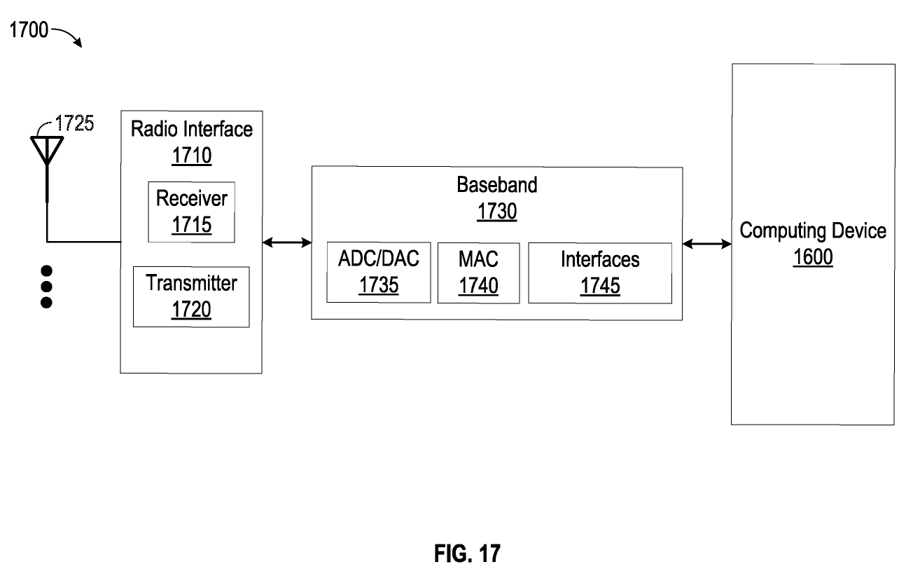

The elements described above of the operating environment 100 (e.g., the AP MLD 102, the STAs104, the non-AP MLD 110, the non-AP STAs 112, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 16 and 17, the elements of the operating environment 100 may be practiced in a computing device 1600 and/or communications device 1700.

FIGS. 2-13 illustrate various example embodiments of control information subfields within an MLPS Control subfield that may be included in a MAC Protocol Data Unit (MPDU). Generally, the illustrated field positions and arrangements are exemplary, and the various fields can be repositioned or reordered in further implementations. For example, fields may be rearranged to improve octet alignment, align with different operational modes, or accommodate specific field position requirements of the IEEE 802.11 standard. In some embodiments, any of the encoding options illustrated in FIGS. 2-13 can be selectively utilized by the non-AP MLD 110 to send the MLPS indication 130. The non-AP MLD 110 may select a particular encoding format based on various factors, such as the specific power management information the non-AP MLD 110 needs to convey (e.g., whether one or both PM modes need to be indicated), the number of bits the non-AP MLD 110 wishes to allocate to the MLPS indication, the number of active links being managed, available space in the A-Control field, and specific requirements of the wireless communication scenario. In other embodiments, the non-AP MLD 110 may be configured or required by the AP MLD 102, other network device, or the wireless standard to utilize only one or more specific encoding formats.

In the various embodiments illustrated, certain Control Information subfields include reserved bits to provide octet alignment and enable future extensibility. Reserved bits are set to 0 by the transmitting device and ignored by the receiving device. The size of reserved fields (indicated as “x bits” in some embodiments) varies depending on the specific field configuration and alignment requirements of each format.

FIG. 2 illustrates an example Aggregated-MPDU (A-MPDU) 200 for transmitting the MLPS indication 130. The A-MPDU 200 comprises a plurality of A-MPDU subframes 210, illustrated as A-MPDU subframe 1, A-MPDU subframe 2, through A-MPDU subframe N, where N represents any suitable number of subframes. Aggregation of multiple MPDUs into an A-MPDU is a technique used in IEEE 802.11 wireless communications to improve throughput by reducing per-frame overhead and enabling more efficient use of the wireless medium.

Each A-MPDU subframe 210 includes a respective MPDU that comprises a MAC header 215. The MAC header 215 includes an A-Control field 220, which is a variable-length field that can contain one or more control subfields providing control information for various purposes. In certain embodiments, the A-Control field 220 includes an MLPS Control Subfield containing a control information subfield with power management information (e.g., the MLPS indication 130).

In the embodiment illustrated in FIG. 2, the control information subfield within the MLPS Control Subfield comprises an MLPM bit 230 and an MLPS Link Bitmap 235. The MLPM bit 230 is a single-bit field that indicates the PM mode being specified for the links identified in the MLPS Link Bitmap 235. For example, when the MLPM bit 230 is set to 0, it indicates active mode (PM=0), meaning that the non-AP STAs 112 operating on the identified links are in an active state and available to receive transmissions. Conversely, when the MLPM bit 230 is set to 1, it indicates power save mode (PM=1), meaning that the non-AP STAs 112 operating on the identified links are entering or remaining in the power save mode.

The MLPS Link Bitmap 235 is a multi-bit field that indicates the links for which the non-AP STAs 112 of the non-AP MLD 110 will adopt the PM mode indicated by the MLPM bit 230. The MLPS Link Bitmap 235 uses a bit-position encoding scheme where each bit position corresponds to a particular link identifier (link ID). Specifically, bit position i of the MLPS Link Bitmap 235 corresponds to link ID i (e.g., bit position 0 corresponds to link ID 0, bit position 1 corresponds to link ID 1, etc.). If a particular bit i in the MLPS Link Bitmap 235 is set to 1, then the non-AP STA 112 operating on the link with link ID i adopts the PM mode indicated by the MLPM bit 230. Conversely, if a bit is set to 0, the corresponding link is not affected by the current MLPS indication, and its PM mode remains unchanged or is governed by other PM mechanisms.

The non-AP MLD 110 can utilize the A-Control field 220 in multiple A-MPDU subframes 210 within the same A-MPDU 200 to indicate links operating in different PM modes. This multi-MPDU approach enables the non-AP MLD 110 to signal both active mode (PM=0) and power save mode (PM=1) across its various links using a single aggregated transmission. For example, the non-AP MLD 110 may indicate the links that should be in active mode (PM=0) by including an MLPS Control Subfield in the A-Control field 220 of A-MPDU subframe 1 with the MLPM bit 230 set to 0 and the MLPS Link Bitmap 235 identifying the active links. Within the same A-MPDU 200, the non-AP MLD 110 may indicate the links that should be in power save mode (PM=1) by including another MLPS Control Subfield in the A-Control field 220 of A-MPDU subframe 2 with the MLPM bit 230 set to 1 and the MLPS Link Bitmap 235 identifying the links entering power save mode. Thus, the A-MPDU 200 can provide complete power management information for both PM modes across multiple links of the non-AP MLD 110 in a single aggregated transmission, improving signaling efficiency while maintaining the relatively simple single-mode encoding structure within each individual MPDU.

This approach is effective when the non-AP MLD 110 is transmitting an A-MPDU 200 containing multiple aggregated MPDUs. The ability to indicate both PM modes relies on the availability of multiple MPDUs within the aggregation. If the non-AP MLD 110 sends an MPDU without aggregation (e.g., during low-traffic conditions, when transmitting control frames that cannot be aggregated, or when the wireless medium conditions do not favor aggregation), the non-AP MLD 110 is limited to indicating links in only one PM mode within the single MLPS A-Control subfield available in that MPDU. Additionally, some implementations require the same A-Control field values across all MPDUs aggregated in an A-MPDU for implementation simplification (e.g., since the receiver of an A-MPDU can process the A-Control field from the first MPDU and does not need to aggregate A-Control across multiple MPDUs). Therefore, an A-MPDU may be limited to indicating one PM mode within A-Control subfields in the MPDUs of the A-MPDU. In such situations, if the non-AP MLD 110 needs to signal that some links are in active mode while other links are in power save mode, it would require either multiple separate transmissions (increasing overhead and latency) or would need to utilize one of the alternative encoding formats described in subsequent embodiments.

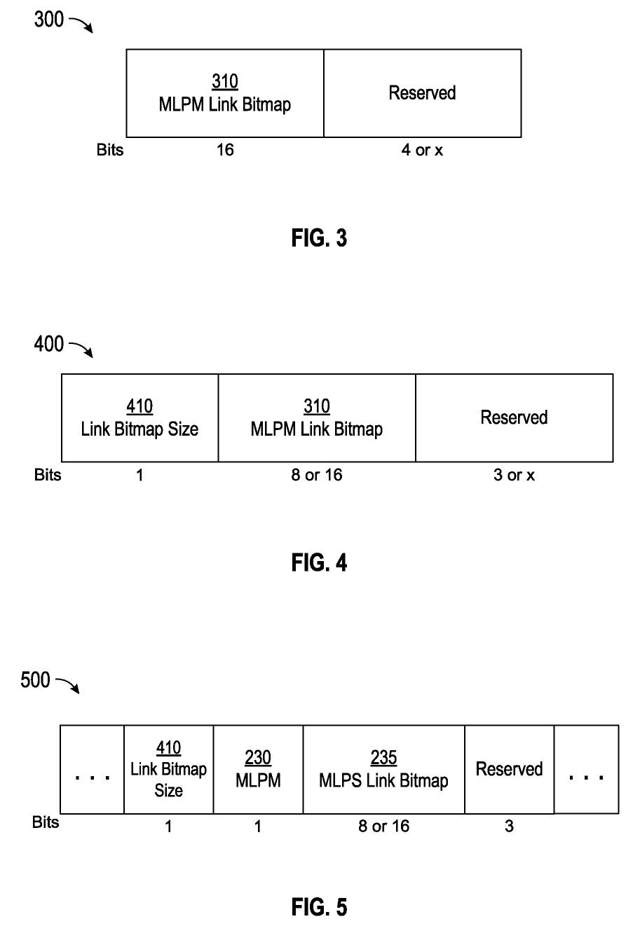

FIG. 3 illustrates a first example Control Information subfield 300 that enables simultaneous indication of both PM=0 and PM=1 modes within a single MLPS Control Subfield. Unlike the encoding scheme illustrated in FIG. 2, which utilizes the MLPM bit 230 to specify a single PM mode for all identified links, the Control Information subfield 300 employs a direct bit-value encoding approach where each bit position directly encodes the specific PM mode for its corresponding link.

The Control Information subfield 300 comprises an MLPM Link Bitmap 310, which is a multi-bit field where the value of each individual bit indicates the PM mode of the link corresponding to that bit position. Specifically, bit position i of the MLPM Link Bitmap 310 corresponds to link ID i, and the value of that bit directly specifies the PM mode for that link. For example, if bit i in the MLPM Link Bitmap 310 is set to 0, it indicates that the non-AP STA 112 operating on link i is currently in or will adopt active mode (PM=0). If a bit i is set to 1, it indicates that the non-AP STA 112 operating on link i is currently in or will adopt power save mode (PM=1).

This direct bit-value encoding scheme provides significant advantages over the approach illustrated in FIG. 2. Most notably, it enables the non-AP MLD 110 to simultaneously signal different PM modes for different links within a single MLPS Control Subfield in a single MPDU. For example, the non-AP MLD 110 can set bits 0 and 2 to 0 (indicating links 0 and 2 are in active mode) while setting bits 1 and 3 to 1 (indicating links 1 and 3 are in power save mode), all within the same MLPM Link Bitmap 310. This capability eliminates the need for multiple MPDUs within an A-MPDU to convey complete PM information across all links, thereby reducing overhead and improving signaling efficiency even when the non-AP MLD 110 transmits a single non-aggregated MPDU.

In the embodiment illustrated in FIG. 3, the length of the MLPM Link Bitmap 310 may be static, such as sixteen bits. A sixteen-bit MLPM Link Bitmap 310 can accommodate Link IDs ranging from 0 to 15, which corresponds to the range of link identifiers permitted by the IEEE 802.11 standard. However, in practical deployment scenarios, an AP MLD typically will not have more than eight links simultaneously active. Accordingly, an eight-bit MLPM Link Bitmap 310 would be sufficient for the foreseeable future in most implementations. The use of a static sixteen-bit bitmap provides complete coverage of all possible link IDs defined by the standard and ensures consistent field sizes, which can simplify parsing and processing. However, this approach may result in inefficient use of control field space when fewer links are actually in use, particularly given the size constraints of the A-Control field.

FIG. 4 illustrates a second example Control Information subfield 400 that addresses the potential inefficiency of a static-length bitmap by incorporating variable-length bitmap encoding. The Control Information subfield 400 includes a Link Bitmap Size field 410 in addition to the MLPM Link Bitmap 310. The Link Bitmap Size field 410 is a control field that indicates the size or length of the MLPM Link Bitmap 310 that follows it, thereby enabling dynamic selection between different bitmap lengths based on the number of links being managed.

In an example implementation, the Link Bitmap Size field 410 is a single-bit field that indicates whether the MLPM Link Bitmap 310 is one octet (eight bits) or two octets (sixteen bits) in length. For instance, when the Link Bitmap Size field 410 is set to 0, it indicates that the MLPM Link Bitmap 310 is one octet, enabling signaling of PM modes for link IDs 0 through 7. When the Link Bitmap Size field 410 is set to 1, it indicates that the MLPM Link Bitmap 310 is two octets, enabling signaling of PM modes for link IDs 0 through 15. The non-AP MLD 110 can select the appropriate bitmap size based on the highest link ID that needs to be addressed in the current MLPS indication. For example, if the non-AP MLD 110 only needs to indicate PM modes for links 0 through 5, it can set the Link Bitmap Size field 410 to 0 and use a single-octet MLPM Link Bitmap 310, thereby conserving eight bits in the A-Control field compared to the sixteen-bit static bitmap approach.

FIG. 5 illustrates a third example Control Information subfield 500 that incorporates variable-length bitmap encoding in the context of the single-PM-mode encoding approach illustrated in FIG. 2. The Control Information subfield 500 includes the MLPM bit 230, the MLPS Link Bitmap 235, and the Link Bitmap Size field 410. This embodiment provides an optimization of the encoding scheme described with respect to FIG. 2 by adding variable-length bitmap capability while retaining the single-PM-mode encoding structure.

The Link Bitmap Size field 410 in the Control Information subfield 500 is used to indicate the size of the MLPS Link Bitmap 235. Similar to the implementation described with respect to FIG. 4, the Link Bitmap Size field 410 indicates whether the MLPS Link Bitmap 235 is one octet or two octets in length. For example, when the Link Bitmap Size field 410 is set to 0, the MLPS Link Bitmap 235 is one octet, and when the Link Bitmap Size field 410 is set to 1, the MLPS Link Bitmap 235 is two octets.

The Control Information subfield 500 may be included in one or more MLPS Control Subfields within the A-Control field 220 of one or more A-MPDU subframes 210 of the A-MPDU 200. When the non-AP MLD 110 utilizes multiple MLPS Control Subfields within an A-MPDU 200 to indicate both PM modes (as described with respect to FIG. 2), the addition of the Link Bitmap Size field 410 enables each individual MLPS indication to be optimally sized. For example, if the non-AP MLD 110 needs to indicate that links 0 and 1 are in active mode and link 7 is in power save mode, it can include a first MLPS Control Subfield with Link Bitmap Size field 410 set to 0 (indicating an eight-bit MLPS Link Bitmap 235) for the PM=0 indication, and a second MLPS Control Subfield with Link Bitmap Size field 410 set to 0 for the PM=1 indication, thereby conserving bits in both MLPS indications compared to using fixed sixteen-bit bitmaps. In some embodiments, the MLPS Link Bitmap 235 is a static size of 8-bits, and the Link Bitmap Size field 410 is excluded from the Control Information subfield 500.

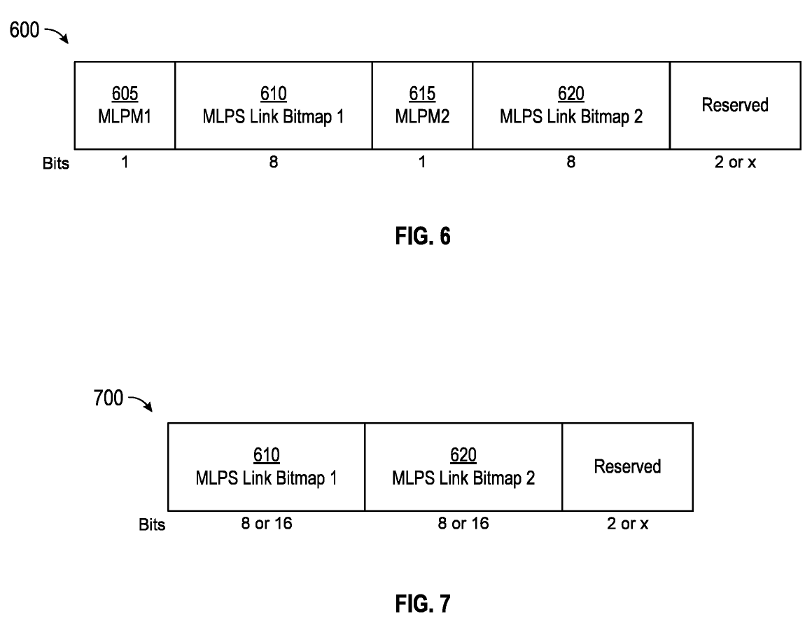

FIG. 6 illustrates a fourth example Control Information subfield 600 that employs a dual-bitmap encoding approach to enable simultaneous indication of both PM=0 and PM=1 modes within a single MLPS Control Subfield. The Control Information subfield 600 comprises a first MLPM bit 605, a first MLPS Link Bitmap 610, a second MLPM bit 615, and a second MLPS Link Bitmap 620.

The first MLPM bit 605 is a single-bit field that indicates the power management mode being specified for the links identified in the first MLPS Link Bitmap 610. The second MLPM bit 615 is a single-bit field that indicates the power management mode being specified for the links identified in the second MLPS Link Bitmap 620. By providing two separate MLPM bits and two corresponding link bitmaps, the Control Information subfield 600 enables explicit specification of two different PM modes within a single control structure.

In an example implementation, the first MLPM bit 605 is set to 0 to indicate that the first MLPS Link Bitmap 610 identifies links that are in or will adopt active mode (PM=0), and the second MLPM bit 615 is set to 1 to indicate that the second MLPS Link Bitmap 620 identifies links that are in or will adopt power save mode (PM=1). Alternatively, the first MLPM bit 605 could be set to 1 and the second MLPM bit 615 could be set to 0, depending on the specific implementation and the information the non-AP MLD 110 needs to convey. The dual-bitmap structure provides flexibility in how the PM modes are assigned to the two bitmap fields. Each of the MLPS Link Bitmaps 610, 620 uses the bit-position encoding scheme described previously, where bit position i corresponds to link ID i. Given the size constraints of the A-Control field within the MAC header, the MLPS Link Bitmaps 610, 620 may be limited to eight bits in length in this format.

FIG. 7 illustrates a fifth example Control Information subfield 700 that provides an optimized variant of the dual-bitmap encoding approach. The Control Information subfield 700 comprises a first MLPS Link Bitmap 610 and a second MLPS Link Bitmap 620, but omits the MLPM bits 605, 615 included in the embodiment of FIG. 6. Without the MLPM bits 605, 615, the PM mode specified by each bitmap can be implicitly determined based on the position or predefined assignment of the bitmaps, thereby eliminating the need for explicit MLPM bit fields.

In example implementations, the PM mode associated with the first MLPS Link Bitmap 610 and the second MLPS Link Bitmap 620 is known or predetermined according to a fixed assignment scheme. For example, the first MLPS Link Bitmap 610 may be designated to indicate which links are in active mode (PM=0), and the second MLPS Link Bitmap 620 may be designated to indicate which links are in power save mode (PM=1). This fixed assignment can be defined by the IEEE 802.11 standard, negotiated during association or multi-link setup, or configured by the AP MLD 102. Because the PM mode assignment is known, the non-AP MLD 110 and the AP MLD 102 can correctly interpret the power management information without requiring explicit MLPM bit fields, thereby conserving two bits in the Control Information subfield.

In the Control Information subfield 700, the first MLPS Link Bitmap 610 and the second MLPS Link Bitmap 620 may be one octet or two octets in length. The ability to use either eight-bit or sixteen-bit bitmaps provides flexibility to accommodate different numbers of active links. The selection between eight-bit and sixteen-bit bitmaps may be indicated by an additional Link Bitmap Size field (not shown in FIG. 7 but analogous to the Link Bitmap Size field 410 described with respect to FIGS. 4 and 5), or may be fixed at a predetermined length based on implementation requirements and A-Control field size constraints.

In certain embodiments, an MLPM Mode field 805 is included in the Control Information subfield to provide dynamic format selection capability, enabling the non-AP MLD 110 to choose between single-bitmap and dual-bitmap encoding formats based on the specific power management information that needs to be communicated. This dynamic format selection provides enhanced flexibility and efficiency by allowing the non-AP MLD 110 to use a compact encoding when only one PM mode needs to be indicated, while also providing the capability to use a more comprehensive dual-bitmap encoding when both PM modes need to be indicated. The MLPM Mode field 805 can be incorporated into various Control Information subfield formats, including those illustrated in FIGS. 2, 5, 6, and 7, to add dynamic format selection capability to those encoding schemes.

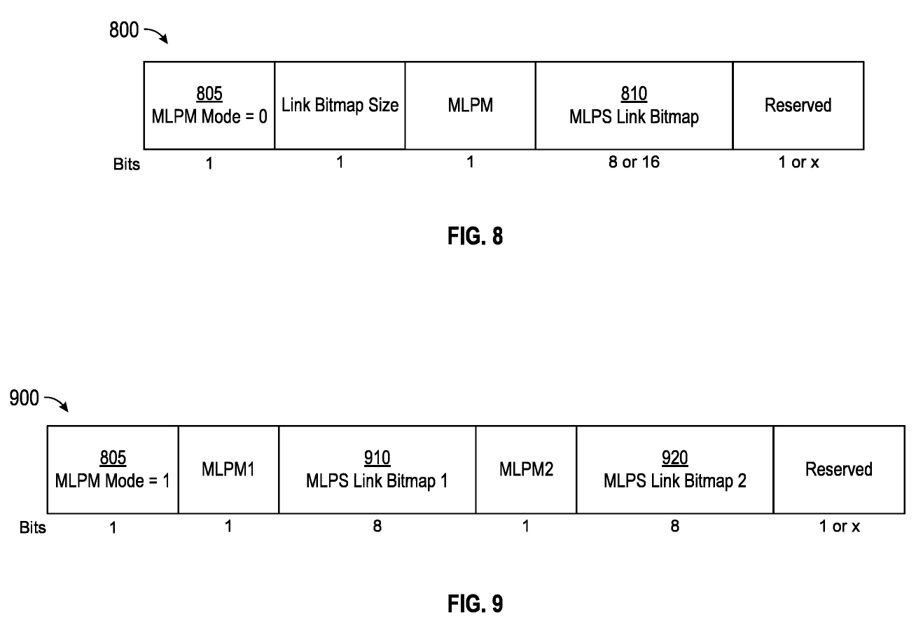

FIG. 8 illustrates a sixth example Control Information subfield 800 with an MLPM Mode field 805 indicating that a single MLPS Link Bitmap is included in the Control Information subfield. In an example implementation, the MLPM Mode field 805 is a single-bit field where a value of 0 indicates single-bitmap mode. When the MLPM Mode field 805 is set to 0, the Control Information subfield 800 includes a single MLPS Link Bitmap 810 that identifies the links for which power management information is being provided.

The Control Information subfield 800 may include additional fields in combination with the MLPM Mode field 805 and the MLPS Link Bitmap 810 to provide enhanced functionality. For example, the Control Information subfield 800 may include a Link Bitmap Size field (such as the Link Bitmap Size field 410 described with respect to FIGS. 4 and 5) to indicate whether the MLPS Link Bitmap 810 is one octet or two octets in length. Additionally, the Control Information subfield 800 may include an MLPM bit (such as the MLPM bit 230 described with respect to FIG. 2) to explicitly indicate which PM mode (PM=0 or PM=1) is being specified for the links identified in the MLPS Link Bitmap 810.

FIG. 9 illustrates a seventh example Control Information subfield 900 with an MLPM Mode field 805 indicating that two MLPS Link Bitmaps are included in the Control Information subfield. In an example implementation, when the MLPM Mode field 805 is set to 1, it indicates dual-bitmap mode. With the MLPM Mode field 805 is set to 1, the Control Information subfield 900 includes a first MLPS Link Bitmap 910 and a second MLPS Link Bitmap 920.

The Control Information subfield 900 may include additional fields to further specify the interpretation of the dual bitmaps. For example, the Control Information subfield 900 may include respective MLPM bits for the first MLPS Link Bitmap 910 and the second MLPS Link Bitmap 920 (similar to the first MLPM bit 605 and second MLPM bit 615 described with respect to FIG. 6) to explicitly indicate which PM mode corresponds to each bitmap. Alternatively, the PM mode assignment for the two bitmaps may be predetermined or implicit based on bitmap position, as described with respect to FIG. 7, thereby eliminating the need for explicit MLPM bits and conserving control field space. The Control Information subfield 900 may also include a Link Bitmap Size field to indicate the length of the bitmaps, or the bitmap lengths may be fixed at a predetermined size such as eight bits each to ensure the total Control Information subfield size remains within A-Control field constraints.

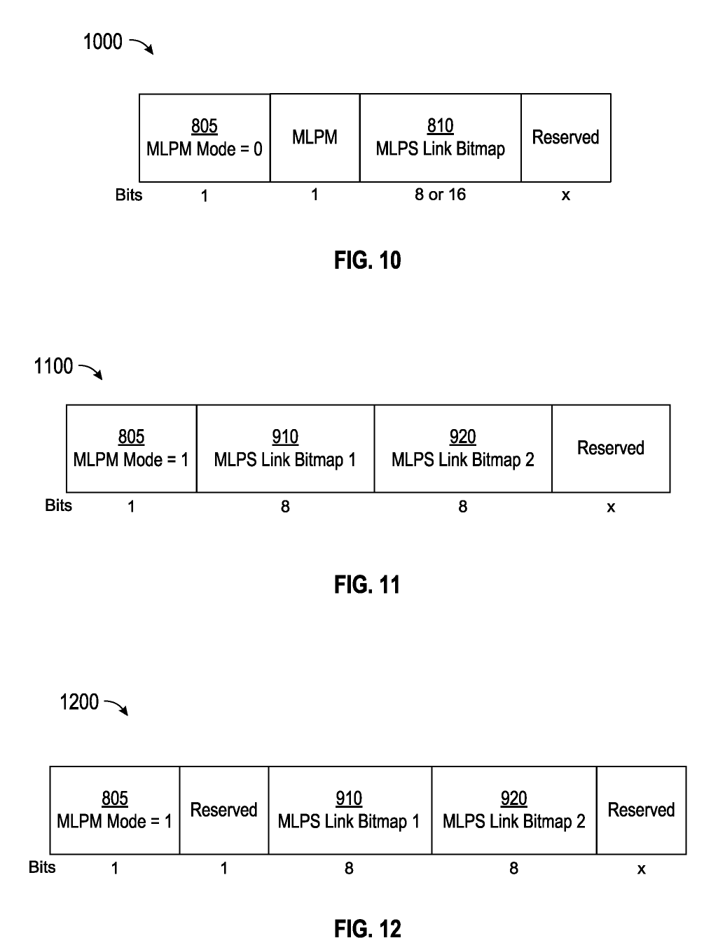

Other example Control Information subfield formats with the MLPM Mode field 805 set to indicate the single MLPS Link Bitmap 810 are illustrated in FIG. 10, an eighth example Control Information subfield 1000, and FIG. 11, a ninth Control Information subfield 1110. Other example Control Information subfield formats with the MLPM Mode field 805 set to indicate the dual-bitmaps are illustrated in FIG. 12, a tenth example Control Information subfield 1000.

In various embodiments, the non-AP MLD 110 may need to provide power management information for only a single PM mode. For example, when the non-AP MLD 110 is bringing all of its links out of power save mode into active mode, it only needs to indicate which links are transitioning to PM=0, and does not need to provide separate information about links remaining in PM=1. Similarly, when the non-AP MLD 110 is putting all of its active links into power save mode, it only needs to indicate which links are transitioning to PM=1. In these single-PM-mode scenarios, the single-bitmap encoding format illustrated in FIGS. 2, 5, 8, and 10 (and the MLPM Link Bitmaps of FIGS. 3-4) provide sufficient signaling capability while minimizing overhead.

In other scenarios, the non-AP MLD 110 may need to provide power management information for both PM modes simultaneously. For example, the non-AP MLD 110 may need to indicate that some links are becoming active while other links are entering power save mode, or may need to provide complete power management state information for all of its links to enable the AP MLD 102 to have full visibility into the current link states. In these dual-PM-mode scenarios, the MLPM Link Bitmaps of FIGS. 3-4 and the dual-bitmap encoding format illustrated in FIGS. 6-7, 9, and 11-12 provide the necessary comprehensive signaling capability.

The MLPM Mode field 805 enables the non-AP MLD 110 to dynamically select between these two encoding formats based on the specific power management information that needs to be conveyed in each transmission. This dynamic selection capability ensures that the MLPS Control Subfield size can be minimized when possible, reducing overhead and conserving the limited space available in the A-Control field, while still providing comprehensive dual-mode signaling capability when needed. By including only the necessary number of bitmaps for each specific MLPS indication, the non-AP MLD 110 can optimize control field usage across multiple transmissions, improving overall signaling efficiency and reducing the likelihood of A-Control field size constraints preventing the inclusion of other important control information.

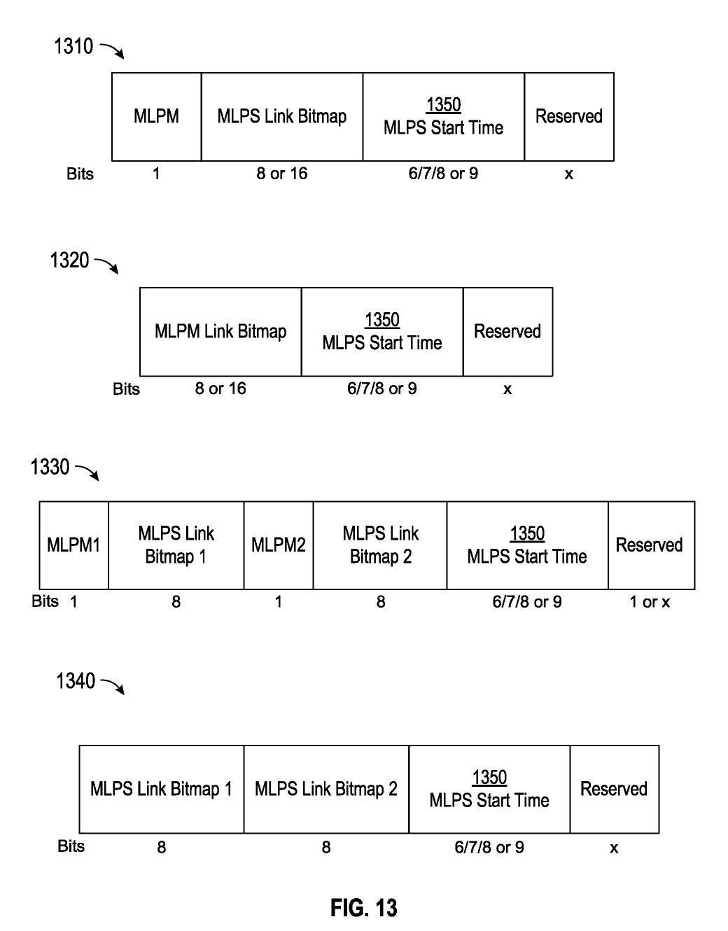

FIG. 13 illustrates various Control Information subfield formats that incorporate timing control functionality to specify when indicated power management mode changes become effective. Specifically, FIG. 13 shows an eleventh example Control Information subfield 1310, a twelfth example Control Information subfield 1320, a thirteenth example Control Information subfield 1330, and a fourteenth example Control Information subfield 1340, each of which includes an MLPM Start Time field 1350.

The MLPM Start Time field 1350 is a multi-bit field that indicates a start time at which the PM mode(s) indicated in the respective Control Information subfield becomes effective for the identified links. This timing functionality enables the non-AP MLD 110 to schedule future PM mode transitions, allowing the AP MLD 102 and the non-AP MLD 110 to coordinate power management changes in advance of their actual implementation. This coordination capability can improve network efficiency by enabling the AP MLD 102 to plan transmissions and resource allocations based on known future link states, and can enable the non-AP MLD 110 to signal planned PM mode changes without requiring the changes to take effect immediately upon transmission of the MLPS indication.

In various embodiments, the MLPM Start Time field 1350 expresses the start time in terms of TSF values. The TSF is a timer maintained by IEEE 802.11 devices that provides a common time reference for synchronizing operations across the network. In an example implementation, the MLPM Start Time field 1350 contains a subset of the TSF bits of the current link on which the A-Control field containing the MLPS indication is transmitted. For example, the MLPM Start Time field 1350 may contain TSF bits 7 to 15, providing a 9-bit time value. The use of a subset of TSF bits rather than the complete TSF value reduces the size of the MLPM Start Time field 1350 while still providing sufficient temporal resolution and range for scheduling PM mode transitions.

When the AP MLD 102 receives an MLPS indication containing the MLPM Start Time field 1350, it compares the value in the MLPM Start Time field 1350 to the corresponding bits of the current TSF value on the link where the indication was received. The indicated PM mode changes become effective when the current TSF value reaches or exceeds the time specified in the MLPM Start Time field 1350. Because only a subset of TSF bits is used, the MLPM Start Time field 1350 implicitly refers to the next occurrence of the specified time value, providing a rolling window for scheduling PM mode transitions. The size and bit positions of the TSF subset can be selected to provide an appropriate balance between field size overhead and the temporal range over which PM mode transitions can be scheduled.

The size of the MLPM Start Time field 1350 can vary depending on implementation requirements and the desired temporal range and resolution. In various embodiments, the MLPM Start Time field 1350 may be 6 bits, 7 bits, 8 bits, or 9 bits in length. A larger MLPM Start Time field 1350 provides a longer scheduling window and potentially finer temporal resolution, while a smaller MLPM Start Time field 1350 reduces overhead in the A-Control field. The appropriate size can be selected based on factors such as expected PM mode transition patterns, network synchronization accuracy, and A-Control field size constraints. In some implementations, the size of the MLPM Start Time field 1350 may be fixed by the IEEE 802.11 standard or negotiated during association or multi-link setup, while in other implementations the size may be dynamically indicated through an additional control field.

In alternative embodiments, the MLPM Start Time field 1350 expresses the start time as a duration or time offset from the current TSF time of the current link on which the A-Control field is transmitted. In this duration-based approach, the value in the MLPM Start Time field 1350 represents a time interval (e.g., in microseconds) from the time of transmission of the MLPS indication to the time when the indicated PM mode changes should become effective. For example, if the MLPM Start Time field 1350 contains a value of 100 and represents a duration in units of 1024 microseconds, the indicated PM mode changes would become effective 102,400 microseconds (approximately 102.4 milliseconds) after transmission of the MLPS indication. This duration-based encoding provides an alternative that may simplify processing in some implementations, as it does not require extraction and comparison of specific TSF bit positions, and can provide more intuitive scheduling of PM mode transitions relative to the signaling event.

The MLPM Start Time field 1350 can be added to any of the Control Information subfield formats described herein, providing timing control capability across the various encoding schemes. The position of the MLPM Start Time field 1350 within the Control Information subfield can vary based on octet alignment considerations, parsing efficiency, and compatibility with other field positions.

In some embodiments, the MLPM Start Time field 1350 is always present in the Control Information subfield when timing control functionality is supported. However, in many operational scenarios, the non-AP MLD 110 may need or prefer to have the indicated PM mode changes take effect immediately upon receipt of the MLPS indication, without a scheduled future start time. In such scenarios, including the MLPM Start Time field 1350 would consume control field space unnecessarily. To address this, certain embodiments include an MLPM Start Time Present field (not explicitly shown in FIG. 13) that indicates whether the MLPM Start Time field 1350 is included in the current Control Information subfield. The MLPM Start Time Present field may be a single-bit flag where a value of 1 indicates that the MLPM Start Time field 1350 is present and should be parsed, and a value of 0 indicates that the MLPM Start Time field 1350 is not present and the indicated PM mode changes take effect immediately or according to default timing rules. This optional inclusion mechanism enables the non-AP MLD 110 to dynamically select whether to include timing information based on the specific requirements of each MLPS indication, optimizing control field usage by including the MLPM Start Time field 1350 only when scheduled PM mode transitions are needed.

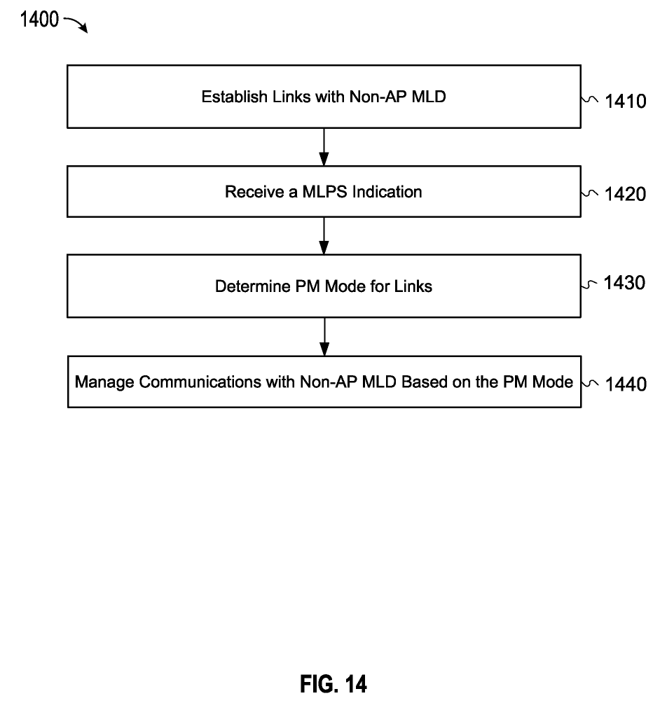

FIG. 14 is a flow diagram illustrating a method 1400 for providing MLPS indications. The method 1400 enables the AP MLD 102 to receive and process MLPS indications 130 from a non-AP MLD 110 and manage communications based on the indicated power management modes.

At stage 1410, the AP MLD 102 establishes a plurality of links with a non-AP MLD 110. At stage 1420, the AP MLD 110 receives an MLPS indication 130 via a link of the plurality of links. The MLPS indication 130 is transmitted by the non-AP MLD (e.g., in a MAC header) and may be received on any of the established links. The MLPS indication 130 comprises a Control Information subfield (e.g., in a MPDU, in an A-MPDU) that provides PM information for the links. The Control Information subfield is included in a MAC header of an MPDU or A-MPDU in example implementations.

At stage 1430, the AP MLD determines a PM mode for two or more links of the plurality of links based on the MLPS indication 130. In some embodiments, the determination includes determining that at least a first link of the two or more links is in an active mode and determining that at least a second link of the two or more links is in a power save mode. Thus, the MLPS indication 130 enables the AP MLD to identify different PM modes for different links within a single indication.

In various embodiments, the MLPS indication comprises a Control Information subfield including a MLPM link bitmap. The MLPM link bitmap comprises a plurality of bit values, where each bit value indicates the PM mode of a respective link of the two or more links. The AP MLD determines the PM mode for the two or more links based on the plurality of bit values. In an example implementation, a first bit value (e.g., 0) indicates the active mode and a second bit value (e.g., 1) indicates the power save mode. The control information subfield may further include a link bitmap size field indicating a size of the MLPM link bitmap, enabling variable-length bitmap encoding.

In other embodiments, the MLPS indication 130 comprises a control information subfield including a first MLPS link bitmap indicating a first subset of the two or more links in the power save mode and a second MLPS link bitmap indicating a second subset of the two or more links in the active mode. This dual-bitmap encoding enables explicit identification of links in each PM mode.

In certain embodiments, the MLPS indication 130 comprises a Control Information subfield including a MLPM mode field that enables dynamic format selection. When the MLPM mode field is set to a first value, the Control Information subfield includes a single MLPS link bitmap. When the MLPM mode field is set to a second value, the Control Information subfield includes two MLPS link bitmaps. This dynamic selection capability allows the non-AP MLD 110 to optimize control field usage based on the specific power management information being conveyed.

In further embodiments, the MLPS indication comprises a Control Information subfield including a MLPM start time field indicating a start time at which the PM mode for the two or more links becomes effective. The MLPM start time field enables the AP MLD to schedule the application of the indicated PM modes at a specified future time rather than immediately upon receipt of the indication.

At stage 1440, the AP MLD 102 manages communications with the non-AP MLD 110 based on the PM mode for the two or more links. The AP MLD 102 utilizes the determined PM mode information to appropriately schedule transmissions and allocate resources. For example, the AP MLD 102 may transmit data to the non-AP MLD 110 via links determined to be in active mode, while refraining from transmitting data on links determined to be in power save mode or applying appropriate power save protocols for those links. This management of communications based on the indicated PM modes improves network efficiency and enables the non-AP MLD 110 to achieve power savings on links operating in power save mode.

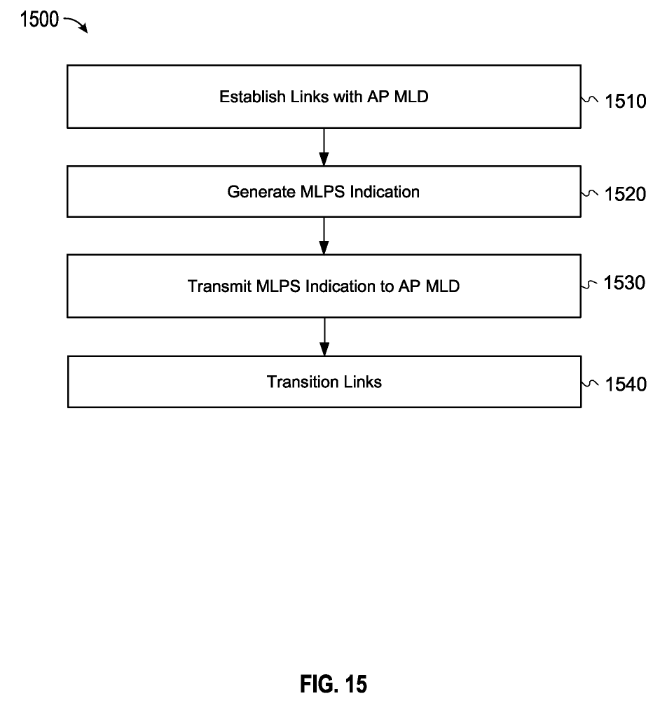

FIG. 15 is a flow diagram illustrating a method 1500 for communicating using MLPS indications. At stage 1510, the non-AP MLD 110 establishes a plurality of links with an AP MLD 102. At stage 1520, the non-AP MLD 110 generates an MLPS indication 130. The MLPS indication 130 comprises a Control Information subfield that indicates a PM mode for two or more links of the plurality of links. The indicated PM mode includes at least a first link of the two or more links in an active mode and at least a second link of the two or more links in a power save mode. Thus, the MLPS indication 130 enables the non-AP MLD 110 to signal different PM modes for different links within a single indication. In various embodiments, the Control Information subfield includes a MLPM link bitmap. In other embodiments, the Control Information subfield includes a first MLPS link bitmap indicating a first subset of the two or more links in the power save mode and a second MLPS link bitmap indicating a second subset of the two or more links in the active mode.

At stage 1530, the non-AP MLD 110 transmits the MLPS indication 130 to the AP MLD 102 via a link of the plurality of links. The MLPS indication 130 may be transmitted via any of the established links, enabling cross-link signaling where power management information for multiple links is conveyed on a single link. The MLPS indication 130 may be included in an A-Control field of an MPDU or A-MPDU transmitted to the AP MLD.

At stage 1540, the non-AP MLD 110 transitions links based on the PM mode indicated in the MLPS indication 130. Specifically, the non-AP MLD 110 transitions at least the first link to active mode and at least the second link to power save mode, as indicated in the MLPS indication 130 transmitted at stage 1530. For links transitioning to active mode, the corresponding non-AP STAs 112 enter an active state where they actively listen for transmissions and can receive data at any time. For links transitioning to power save mode, the corresponding non-AP STAs 112 enter a low-power state where they conserve battery power and may not be actively listening for transmissions. The transitions may occur immediately upon transmission of the MLPS indication or at the time specified in the MLPS start time field if included in the Control Information subfield.

FIG. 16 is a block diagram of a computing device 1600. As shown in FIG. 16, computing device 1600 may include a processing unit 1610 and a memory unit 1615. Memory unit 1615 may include a software module 1620 and a database 1625. While executing on processing unit 1610, software module 1620 may perform, for example, processes for providing MLPS indications. Computing device 1600, for example, may provide an operating environment for the AP MLD 102, the STAs104, the non-AP MLD 110, the non-AP STAs 112, and the like. The AP MLD 102, the STAs104, the non-AP MLD 110, the non-AP STAs 112, and the like may operate in other environments and are not limited to computing device 1600.

Computing device 1600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1600 may comprise any computer operating environment, such as hand-held devices, multiprocessor systems, microprocessor-based or programmable sender electronic devices, minicomputers, mainframe computers, and the like. Computing device 1600 may also be practiced in distributed computing environments where tasks are performed by remote processing devices. The aforementioned systems and devices are examples, and computing device 1600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units, and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 1600 on the single integrated circuit (chip).

FIG. 17 illustrates an implementation of a communications device 1700 that may implement one or more of the AP MLD 102, the STAs104, the non-AP MLD 110, the non-AP STAs 112, etc. In various implementations, the communications device 1700 may comprise a logic circuit. The logic circuit may include physical circuits to perform operations described for one or more of the AP MLD 102, the STAs104, the non-AP MLD 110, the non-AP STAs 112, etc., for example. As shown in FIG. 17, the communications device 1700 may include one or more of, but is not limited to, a radio interface 1710, baseband circuitry 1730, and/or the computing device 1600.

The communications device 1700 may implement some or all of the structures and/or operations for the AP MLD 102, the STAs104, the non-AP MLD 110, the non-AP STAs 112, etc., storage medium, and logic circuit in a single computing entity, such as entirely within a single device. Alternatively, the communications device 1700 may distribute portions of the structure and/or operations using a distributed system architecture, such as a client station server architecture, a peer-to-peer architecture, a master-slave architecture, etc.

A radio interface 1710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1710 may include, for example, a receiver 1715 and/or a transmitter 1720. The radio interface 1710 may include bias controls, a crystal oscillator, and/or one or more antennas 1725. In additional or alternative configurations, the radio interface 1710 may use oscillators and/or one or more filters, as desired.

The baseband circuitry 1730 may communicate with the radio interface 1710 to process, receive, and/or transmit signals and may include, for example, an Analog-To-Digital Converter (ADC) for down converting received signals with a Digital-To-Analog Converter (DAC) 1735 for up converting signals for transmission. Further, the baseband circuitry 1730 may include a baseband or PHY layer processing circuit for the PHY link layer processing of respective receive/transmit signals. Baseband circuitry 1730 may include, for example, a MAC processing circuit 1740 for MAC/data link layer processing. Baseband circuitry 1730 may include a memory controller for communicating with MAC processing circuit 1740 and/or a computing device 1600, for example, via one or more interfaces 1745.

In some configurations, PHY processing circuit may include a frame construction and/or detection module, in combination with additional circuitry such as a buffer memory, to construct and/or deconstruct communication frames. Alternatively or in addition, MAC processing circuit 1740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
establishing, by an access point (AP) multi-link device (MLD), a plurality of links with a non-AP MLD;
receiving, by the AP MLD and via a link of the plurality of links, a multi-link power save (MLPS) indication, wherein the MLPS indication is in a Media Access Control (MAC) header;
determining, by the AP MLD, a power management (PM) mode for two or more links of the plurality of links based on the MLPS indication; and
managing, by the AP MLD, communications with the non-AP MLD based on the PM mode for the two or more links.

2. The method of claim 1, wherein:
the MLPS indication comprises a control information subfield including a multi-link PM (MLPM) link bitmap, wherein the MLPM link bitmap comprises a plurality of bit values each indicating the PM mode of a respective link of the two or more links; and
determining the PM mode for the two or more links is based on the plurality of bit values.

3. The method of claim 2, wherein a first bit value indicates an active mode and a second bit value indicates a power save mode.

4. The method of claim 2, wherein the control information subfield further includes a link bitmap size field indicating a size of the MLPM link bitmap.

5. The method of claim 1, wherein the MLPS indication comprises a control information subfield including:
a first MLPS link bitmap indicating a first subset of the two or more links in a power save mode; and
a second MLPS link bitmap indicating a second subset of the two or more links in an active mode.

6. The method of claim 1, wherein:
the MLPS indication comprises a control information subfield including a MLPM mode field;
when the MLPM mode field is set to a first value, the control information subfield includes a single MLPS link bitmap; and
when the MLPM mode field is set to a second value, the control information subfield includes two MLPS link bitmaps.

7. The method of claim 1, wherein:
the MLPS indication comprises a control information subfield including a MLPM start time field indicating a start time at which the PM mode for the two or more links becomes effective.

8. A system comprising:
a memory storage; and
a processing unit coupled to the memory storage, wherein the processing unit is operative to:
establishing a plurality of links with a non-access point (AP) multi-link device (MLD);
receive, via a link of the plurality of links, a multi-link power save (MLPS) indication , wherein the MLPS indication is in a Media Access Control (MAC) header;
determine a power management (PM) mode for two or more links of the plurality of links based on the MLPS indication; and
manage communications with the non-AP MLD based on the PM mode for the two or more links.

9. The system of claim 8, wherein:
the MLPS indication comprises a control information subfield including a multi-link PM (MLPM) link bitmap, wherein the MLPM link bitmap comprises a plurality of bit values each indicating the PM mode of a respective link of the two or more links; and
determining the PM mode for the two or more links is based on the plurality of bit values.

10. The system of claim 9, wherein a first bit value indicates an active mode and a second bit value indicates a power save mode.

11. The system of claim 9, wherein the control information subfield further includes a link bitmap size field indicating a size of the MLPM link bitmap.

12. The system of claim 8, wherein the MLPS indication comprises a control information subfield including:
a first MLPS link bitmap indicating a first subset of the two or more links in a power save mode; and
a second MLPS link bitmap indicating a second subset of the two or more links in an active mode.

13. The system of claim 8, wherein:
the MLPS indication comprises a control information subfield including a MLPM mode field;
when the MLPM mode field is set to a first value, the control information subfield includes a single MLPS link bitmap; and
when the MLPM mode field is set to a second value, the control information subfield includes two MLPS link bitmaps.

14. The system of claim 8, wherein:
the MLPS indication comprises a control information subfield including a MLPM start time field indicating a start time at which the PM mode for the two or more links becomes effective.

15. A non-transitory computer-readable medium that stores a set of instructions which when executed perform a method comprising:
establishing a plurality of links with a non-access point (AP) multi-link device (MLD);
receiving, via a link of the plurality of links, a multi-link power save (MLPS) indication, wherein the MLPS indication is in a Media Access Control (MAC) header;
determining a power management (PM) mode for two or more links of the plurality of links based on the MLPS indication; and
managing communications with the non-AP MLD based on the PM mode for the two or more links.

16. The non-transitory computer-readable medium of claim 15, wherein:
the MLPS indication comprises a control information subfield including a multi-link PM (MLPM) link bitmap, wherein the MLPM link bitmap comprises a plurality of bit values each indicating the PM mode of a respective link of the two or more links; and
determining the PM mode for the two or more links is based on the plurality of bit values.

17. The non-transitory computer-readable medium of claim 16, wherein a first bit value indicates an active mode and a second bit value indicates a power save mode.

18. The non-transitory computer-readable medium of claim 15, wherein the MLPS indication comprises a control information subfield including:
a first MLPS link bitmap indicating a first subset of the two or more links in a power save mode; and
a second MLPS link bitmap indicating a second subset of the two or more links in an active mode.

19. The non-transitory computer-readable medium of claim 15, wherein:
the MLPS indication comprises a control information subfield including a MLPM mode field;
when the MLPM mode field is set to a first value, the control information subfield includes a single MLPS link bitmap; and
when the MLPM mode field is set to a second value, the control information subfield includes two MLPS link bitmaps.

20. The non-transitory computer-readable medium of claim 15, wherein:
the MLPS indication comprises a control information subfield including a MLPM start time field indicating a start time at which the PM mode for the two or more links becomes effective.
